(19) United States
(12) Patent Application Publication
(10) Pub. No.: US 2006/0012690 A1
(43) Pub. Date: Jan. 19, 2006

(54) Image capturing apparatus and method of acquiring image

(75) Inventors: Kenji Nakamura, Takatsuki-shi (JP); Masahiro Kitamura, Osaka-shi (JP); Shinichi Fujii, Osaka-shi (JP); Yasuhiro Kingetsu, Sakai-shi (JP); Dai Shintani, Izumi-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA PHOTO IMAGING, INC.,

(21) Appl. No.: 11/056,325

(22) Filed: Feb. 11, 2005

(30) Foreign Application Priority Data
Jul. 14, 2004 (JP) JP2004-207131

(51) Int. Cl. H04N 5/76

(52) U.S. Cl. 348/231.6

(57) ABSTRACT

With an image capturing apparatus placed in a photographing condition specification mode, a controller sets a plurality of photographing conditions corresponding to a variable condition item in response to the selection of the variable condition item by a user. Thereafter, the user manipulates a rear manipulation part to specify a specific photographing condition regarding the variable condition item prior to an actual photographing operation. In response to a photographing start instruction given by a press of a shutter release button, a plurality of images corresponding to the respective photographing conditions regarding the variable condition item are acquired in time sequence and temporarily stored in a memory. Then, a single image that most satisfies the specific photographing condition specified prior to the actual photographing operation is automatically extracted from among the plurality of images temporarily stored in the memory, and is stored in a memory card. The remaining images are, for example, deleted.

This application is based on application No. JP2004-207131 filed in Japan, the contents of which are hereby incorporated by reference.

### BACKGROUND OF THE INVENTION

1. Field of the Invention

The present invention relates to a technique for acquiring an image.

2. Description of the Background Art

A typical image capturing apparatus is capable of acquiring images in accordance with scenes to be photographed by appropriately effecting autofocus (AF) control, automatic exposure (AE) control, auto white balance (AWB) control, a zoom operation and the like.

Such an image capturing apparatus automatically sets photographing conditions or parameters which satisfy predetermined requirements with regard to photographing condition items including focusing, exposure, white balance and the like by effecting the AF control, the AE control, the AWB control and the like, and thereafter performs actual photographing in response to a photographing instruction given by user's manipulation.

However, such an image capturing apparatus fails to acquire an appropriate image if a subject or a situation (or photographic situation) around the subject changes abruptly. Examples of the abrupt change in photographic situation include a case where clouds block out the sun to create dark conditions simultaneously with the issue of the photographing instruction, and a case where the subject moves quickly to cause a change in camera-to-subject distance. In such cases, because different conditions than the photographing conditions set in advance as described above become appropriate, it is impossible to obtain a desired image if photographing is performed under the photographing conditions set in advance without correction.

### SUMMARY OF THE INVENTION

The present invention is intended for an image capturing apparatus.

According to the present invention, the image capturing apparatus comprises: an imaging part for outputting an image signal at a frame rate relatively higher than a frame rate for use during image display; a setting part for setting a plurality of photographing conditions regarding a predetermined photographing condition item; a specification part for specifying a first condition regarding the predetermined photographing condition item prior to a photographing operation; a photographing control part for causing the imaging part to perform the photographing operation for acquiring a plurality of images corresponding to the plurality of photographing conditions, respectively, while successively adopting the plurality of photographing conditions in time sequence; an extraction part for extracting an image that most satisfies the first condition from among the plurality of images; and a storage control part for performing image processing on at least one or all of the plurality of images so that each of a remainder of the plurality of images not extracted by the extraction part is relatively lower in data capacity than the image extracted by the extraction part, to effect a storage process for storing a result of the image processing in a storage medium.

The image capturing apparatus achieves the acquisition of a desired image on every occasion even if there is an abrupt change in photographic situation.

According to another aspect of the present invention, the predetermined photographing condition item includes at least one item among focusing, exposure, image magnification and white balance.

The image capturing apparatus can easily acquire an image satisfying a desired condition about focusing, exposure, image magnification, white balance, and the like.

The present invention is also intended for a method of acquiring an image.

It is therefore an object of the present invention to provide an image capturing technique which is capable of acquiring a desired image on every occasion even if there is an abrupt change in photographic situation.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an external appearance of an image capturing apparatus according to a preferred embodiment of the present invention;

FIG. 2 is a rear view showing the external appearance of the image capturing apparatus according to the preferred embodiment of the present invention;

FIG. 3 is a block diagram showing a functional construction of the image capturing apparatus according to the preferred embodiment of the present invention;

FIG. 4 is a view for illustrating a method of selecting an item regarding which a photographing condition is to be changed;

FIG. 5 is a view for illustrating the definition of an AF area;

FIG. 6 is a flow chart illustrating an operation in a photographing condition specification mode;

FIG. 7 illustrates images as temporarily stored in a memory;

FIG. 8 is a timing diagram illustrating an actual photographing operation in the photographing condition specification mode;

FIG. 9 is a view illustrating a screen for specification of a condition regarding exposure;

FIG. 10 is a view illustrating a screen for specification of a condition regarding white balance;

FIG. 11 is a view illustrating a screen for specification of a condition regarding image magnification; and

FIG. 12 is a flow chart illustrating an operation in the photographing condition specification mode.

### DESCRIPTION OF THE PREFERRED EMBODIMENTS

A preferred embodiment according to the present invention will now be described with reference to the drawings.

### Overview of Image Capturing Apparatus

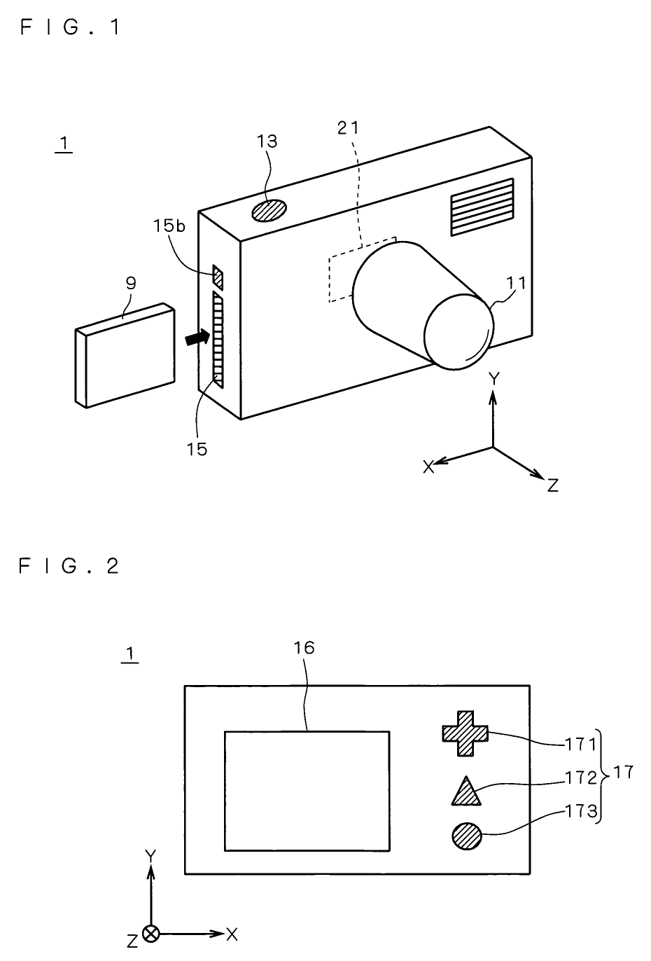

FIG. 1 is a perspective view showing an external appearance of an image capturing apparatus 1 according to the preferred embodiment of the present invention. FIG. 2 is a rear view showing the external appearance of the image capturing apparatus 1. Three axes X, Y and Z orthogonal to each other are shown in FIGS. 1 and 2 for the purpose of clarifying an orientational relationship.

The image capturing apparatus 1 is constructed in the form of a digital camera, and is provided with a taking lens device 11 on the front surface thereof. An imaging device 21 for converting an optical image of a subject incident thereon through the taking lens device 11 into an electrical image signal is provided behind the taking lens device 11. The imaging device 21 used in this preferred embodiment is of a CMOS type. A CCD may be used as the imaging device.

The taking lens device 11 includes a lens system drivable along an optical axis, and is constructed so that driving the lens system along the optical axis achieves the focusing of the optical image of the subject image-formed on the imaging device 21.

A shutter release button 13 is provided on the upper surface of the image capturing apparatus 1. For photographing a subject, a user presses the shutter release button 13 to provide an instruction (also referred to hereinafter as a “photographing start instruction”) for causing the image capturing apparatus 1 to start a photographing operation.

A side surface of the image capturing apparatus 1 is formed with a card receiving slot 15 for insertion of a memory card 9 therein. The memory card 9 is a recording medium for storing therein image data obtained during an actual photographing operation caused by a press of the shutter release button 13 by the user. The side surface of the image capturing apparatus 1 is further formed with a card eject button 15b. The user can eject the memory card 9 from the card receiving slot 15 by pressing the card eject button 15b.

The rear surface of the image capturing apparatus 1 is provided with an LCD (liquid crystal display) 16, and a rear manipulation part 17. The LCD 16 functions as a display element for producing a live view display for displaying a subject in the form of a moving picture prior to actual photographing, and for displaying captured images and the like. The rear manipulation part 17 includes a cross switch 171 and buttons 172 and 173. By pressing the cross switch 171, the user can change a selection among various items on a screen displayed on the LCD 16, and achieve the increase and decrease in image magnification, and the like. By pressing the execution button 172, the user can execute various operations, the determination of the selection, and the like. By pressing the mode selection button 173, the user can make a mode selection between a plurality of modes such as a playback mode, and a recording mode including a photographing condition specification mode to be described later and a mode (also referred to hereinafter as a “normal photographing mode”) in which normal photographing is carried out as with a typical digital camera.

### Functional Construction of Image Capturing Apparatus

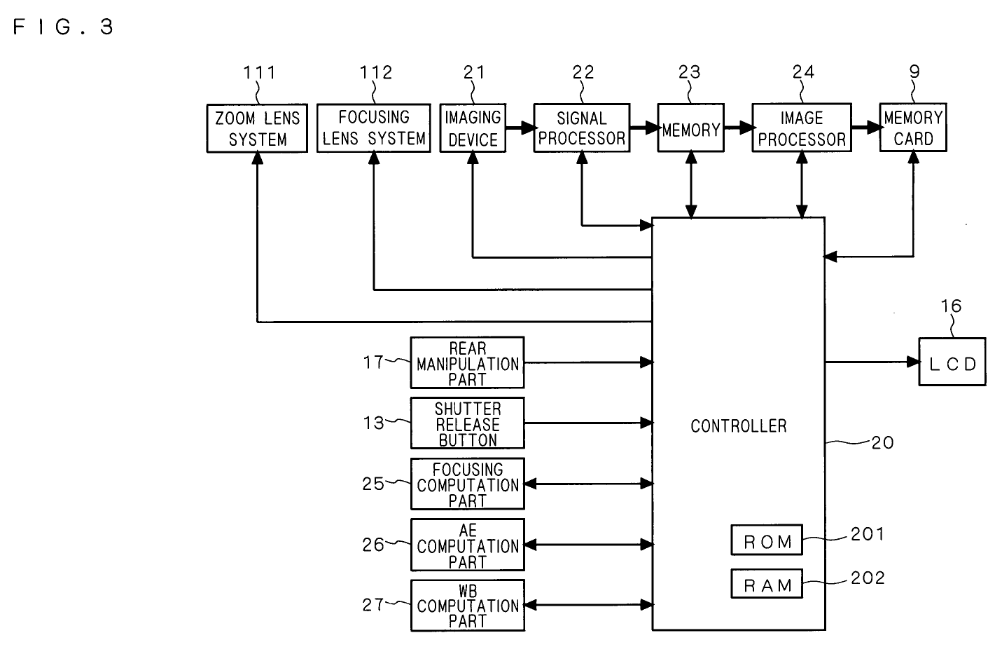

FIG. 3 is a block diagram showing a functional construction of the image capturing apparatus 1.

The taking lens device 11 includes a lens system (also referred to hereinafter as a “zoom lens system”) 111 for changing the image magnification, and a lens system (also referred to hereinafter as a “focusing lens system”) 112 for achieving the focusing of the image of a subject image-formed on the imaging device 21. The focusing lens system 112 is driven back and forth along the optical axis of the taking lens device 11 to allow the acquisition of in-focus images of subjects positioned at various distances.

The imaging device 21 performs a photoelectric conversion based on the image of the subject image-formed through the zoom lens system 111 and the focusing lens system 112 to generate an image signal, thereby outputting the image signal to a signal processor 22.

A driving mode (or a readout mode) of the imaging device 21 includes two modes: a draft mode and an actual photographing mode. The draft mode is a readout mode for generating a preview image for live view display prior to the photographing (or “actual photographing”) during which an image is acquired and stored in the memory card 9 and the like. The draft mode is applied during the so-called live view display. In the draft mode, the imaging device 21 is driven so as to read one out of every eight horizontal lines, for example, when reading one frame of the image signal. The actual photographing mode is a readout mode in which the image signal is read from all of the pixels of the imaging device 21 during the actual photographing.

In the photographing condition specification mode to be described later, the rate (or frame rate) at which the image signal is read from the imaging device 21 in the actual photographing mode is relatively higher than the frame rate in the draft mode. For example, the frame rate in the draft mode is 30 frames per second (30 fps), whereas the frame rate in the actual photographing mode is 300 frames per second (300 fps) which is ten times higher. In other words, one frame of the image signal is read and outputted from the imaging device 21 every 1/30 of a second in the draft mode in which the image signal is read for the live view display, whereas one frame of the image signal is read and outputted from the imaging device 21 every 1/300 of a second in the actual photographing mode.

The signal processor 22 includes a CDS (correlated double sampler), an amplifier, and an A-D converter. The image signal from the imaging device 21 is sampled in the CDS, subjected to desired amplification in the amplifier, and then converted into a digital signal in the A-D converter. The image signal (also referred to simply as an “image”) outputted from the signal processor 22 is temporarily stored in a memory 23. The image temporarily stored in the memory 23 is sent to an image processor 24, and is also sent to a focusing computation part 25, an AE computation part 26, and a WB computation part 27 as appropriate.

The focusing computation part 25 calculates, for example, the sum of the absolute values of the differences between pixel values of adjacent pixels of a partial image within an evaluation area (also referred to hereinafter as an “AF area”) defined in the image provided from the memory 23, to provide the calculated sum as an evaluation value (also referred to hereinafter as an “AF evaluation value”) for evaluation of the status of focusing to a controller 20. The AE computation part 26 calculates exposure control values (shutter speed, aperture value, gain value and the like) in accordance with the brightness (or subject brightness) of the image provided from the memory 23 to output the exposure control values to the controller 20 during the live view display. The WB computation part 27 calculates a WB-adjusting gain value (also referred to hereinafter as a “WB gain value”) for optimization of the white balance (or WB) of the image, based on the pixel values of the image provided from the memory 23, to output the WG gain value to the controller 20.

The image processor 24 performs image processing including the adjustment of the white balance based on the WB gain value, gamma correction, aperture control, and the like upon images. During the actual photographing, the image processor 24 performs a compression process on an image to be stored in the memory card 9 as appropriate, and the image subjected to the compression process is then stored in the memory card 9. During the live view display, the image outputted from the image processor 24 is converted into a size depending on the number of display pixels of the LCD 16, and is provided as a visible output from the LCD 16. During the live view display, live view images (i.e., still images constituting a live view display) displayed on the LCD 16 are updated in accordance with the frame rate of the imaging device 21, for example, every 1/30 of a second.

The controller 20 principally includes a CPU, a ROM 201, a RAM 202 and the like, and exercises centralized control over the components in the image capturing apparatus 1. In the controller 20, the CPU reads and executes a predetermined program stored in the ROM 201 or the like to implement various computations, control, and the like. The operations in the photographing condition specification mode to be described later are also implemented by various functions of the controller 20. The ROM 201 stores therein a plurality of (for example, ten) stepwise different photographing conditions for each of the items (“focusing,” “exposure,” “white balance” and “image magnification”), the photographing conditions being varied during photographing. The items relating to the photographing conditions, such as “focusing,” “exposure,” “white balance” and “image magnification” are also referred to hereinafter as “photographing condition items.”

The rear manipulation part 17 sends various signals to the controller 20 in response to the press of the cross switch 171 and the buttons 172 and 173.

The shutter release button 13 is a two-position switch capable of detecting a half pressed position (S1) and a fully pressed position (S2). In the normal photographing mode, pressing the shutter release button 13 into the half pressed position (S1) during the live view display effects general autofocus control, automatic exposure control and white balance control, and subsequently pressing the shutter release button 13 into the fully pressed position (S2) effects the actual photographing operation. In the photographing condition specification mode, the shutter release button 13, upon being pressed into the fully pressed position (S2), issues the photographing start instruction indicative of the start of the actual photographing operation to the controller 20, whereby the image capturing apparatus 1 performs a series of actual photographing operations to be described later.

Description will be given on the operation of the image capturing apparatus 1 when the photographing condition specification mode is set.

### Operation in Photographing Condition Specification Mode

The operation of the image capturing apparatus 1 in the photographing condition specification mode will be briefly described.

In the photographing condition specification mode, a user can select at least one of the photographing condition items (i.e., at least one of the items: “focusing,” “exposure,” “white balance” and “image magnification”) regarding which the conditions are to be varied during photographing, before the actual photographing starts. When the user specifies a single photographing condition regarding the selected photographing condition item (also referred to hereinafter as a “variable condition item”) regarding which the conditions are to be varied during photographing and causes the image capturing apparatus 1 to start the actual photographing operation, the image capturing apparatus 1 performs photographing a plurality of times while stepwise varying the photographing conditions regarding the variable condition item. Thereafter, a single image that most satisfies the single photographing condition (also referred to hereinafter as a “specific photographing condition”) specified prior to the photographing by the user is extracted from among a plurality of images captured by the plurality of processes of photographing, and is stored in the memory card 9. The remainder of the plurality of images which are not extracted are deleted.

The operations in the photographing condition specification mode will be described in detail.

### Selection of Variable Condition Item

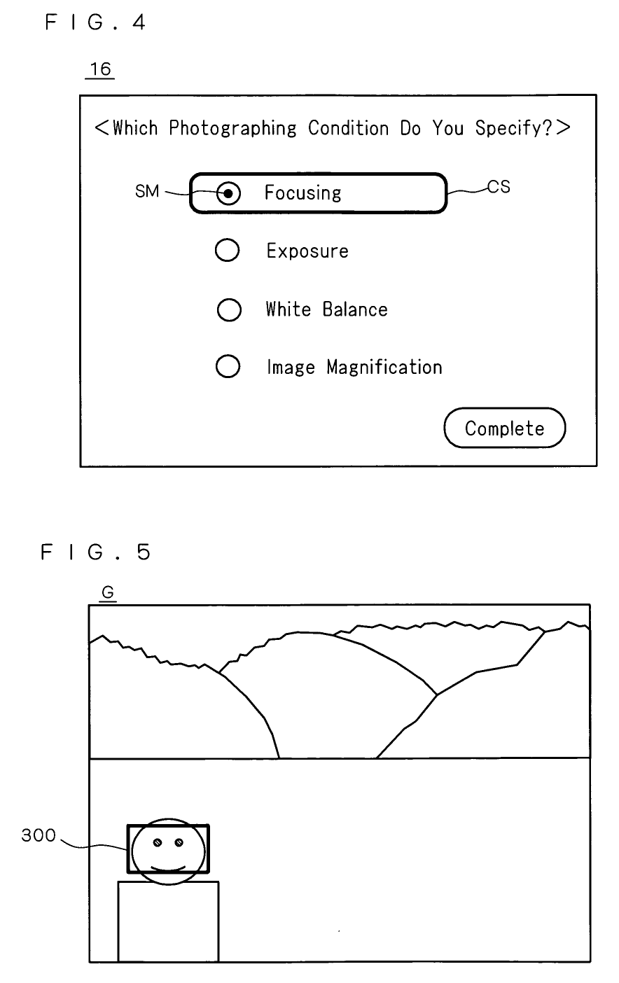

FIG. 4 is a view illustrating a screen (also referred to hereinafter as a “selection screen”) for selection of the variable condition item. When the user presses the mode selection button 173 to place the image capturing apparatus 1 in the photographing condition specification mode, the selection screen as shown in FIG. 4 is displayed on the LCD 16.

On the selection screen shown in FIG. 4 are displayed the following items: four items (“focusing,” “exposure,” “white balance” and “image magnification”) prepared as a choice, and an item “complete” for completion of the selection of the items, these items being arranged vertically in order.

With the selection screen of FIG. 4 displayed on the LCD 16, the user presses the upper or lower button of the cross switch 171 to place a box cursor CS at one of the items: “focusing,” “exposure,” “white balance,” “image magnification” and “complete.” When the user places the box cursor CS at any one of the four items of choice and then presses the execution button 172, a mark (also referred to hereinafter as a “selection mark”) SM is added to the left of the item at which the box cursor CS is placed to indicate that the item is selected. When, with the selection mark SM added as appropriate, the user places the box cursor CS at the item “complete” and presses the execution button 172, then the item to which the selection mark SM is added is selected as the variable condition item.

In response to the selection of each variable condition item, the controller 20 reads the plurality of photographing conditions corresponding to each variable condition item from the ROM 201 to the RAM 202 to set the read photographing conditions as those for use in photographing. The plurality of photographing conditions set in this process are, for example, as follows. When the variable condition item is “focusing,” the photographing conditions are a plurality of positions of the focusing lens system 112 which are stepwise different from each other by the amount of the depth of field across the range of driving of the focusing lens system 112. When the variable condition item is “exposure,” the photographing conditions are a plurality of exposure values stepwise different from each other in the range from a low exposure value to a high exposure value. When the variable condition item is “white balance,” the photographing conditions are a plurality of white balances stepwise different from each other in the range from a white balance for generation of a reddish image to a white balance for generation of a bluish image. When the variable condition item is “image magnification,” the photographing conditions are a plurality of image magnifications (or a plurality of positions of the zoom lens system 111) stepwise different from each other in the range from a wide-angle end to a telephoto end.

After one or more variable condition items are selected in this manner, the screen displayed on the LCD 16 is changed to a screen (also referred to hereinafter as a “condition specification screen”) for user's specification of the single photographing condition regarding each selected variable condition item. If two or more variable condition items are selected, the condition specification screens for the respective variable condition items are successively displayed in time sequence. However, the selection of only “focusing” as the variable condition item will be described for simplicity of discussion.

### Specification of Photographing Condition Regarding Focusing

FIG. 5 is a view illustrating a condition specification screen G for specification of the single photographing condition (or specific photographing condition) regarding “focusing.” If only “focusing” is selected as the variable condition item, the screen displayed on the LCD 16 is changed from the selection screen shown in FIG. 4 to the condition specification screen G shown in FIG. 5.

With reference to FIG. 5, the condition specification screen G shows a box 300 superimposed on a live view image. With the condition specification screen G displayed on the LCD 16, the user can place the box 300 at the position of a subject desired to be in focus on a live view image by pressing the cross switch 171 as appropriate. With the box 300 placed at the position of the desired subject, the user can specify the single photographing condition (or specific photographing condition) that the subject included in the box 300 be brought into focus, by pressing the execution button 172 prior to the actual photographing operation. The area within the box 300 defined herein is used after the actual photographing as an objective area (or AF area) for calculation of the AF evaluation value for evaluation of the status of focusing. The specific photographing condition specified by the user in this manner is stored in the RAM 202.

### Example of Operational Flow in Photographing Condition Specification Mode

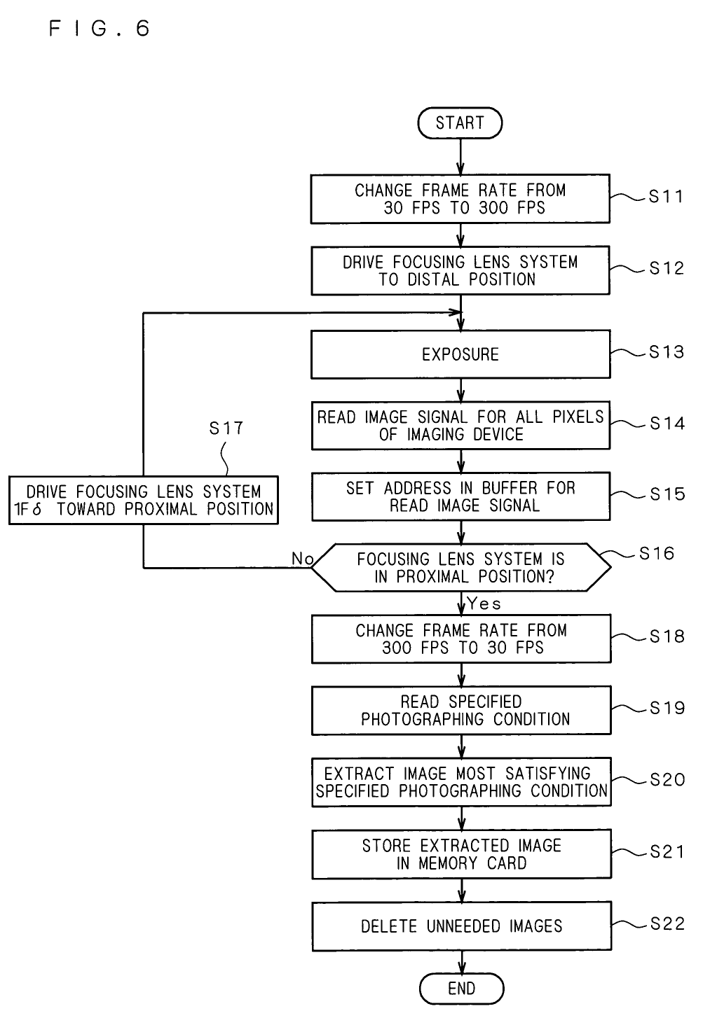

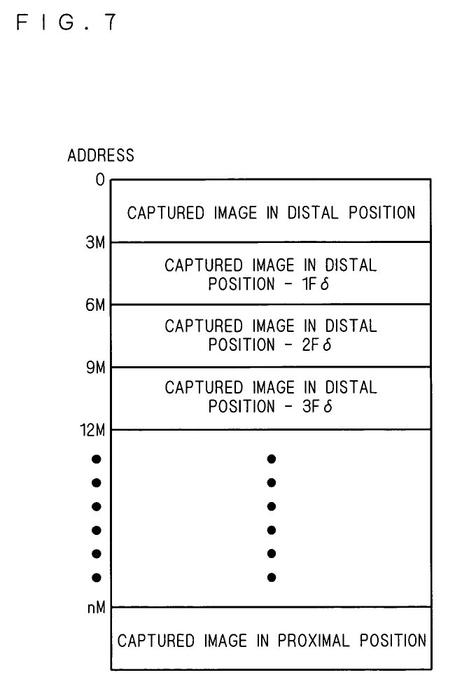

FIG. 6 is an operational flow chart illustrating the actual photographing and storage process of the image capturing apparatus 1 placed in the photographing condition specification mode. The operational flow in the case where only “focusing” is selected as the variable condition item is shown in FIG. 6. This operational flow is implemented under the control of the controller 20.

As described above, when the user presses the shutter release button 13 into the fully pressed position (S2) after specifying the specific photographing condition on the condition specification screen G as shown in FIG. 5, the operational flow shown in FIG. 6 starts, and the processing proceeds to Step S11 of FIG. 6.

In Step S11, the rate (frame rate) at which the image signal is read from the imaging device 21 is changed from 30 frames per second (30 fps) to 300 frames per second (300 fps), and the processing proceeds to Step S12. Specifically, in Step S11, the frame rate in the imaging device 21 is changed to a relatively higher frame rate than the frame rate used prior to the photographing start instruction in response to the press of the shutter release button 13 by the user, i.e. the photographing start instruction.

In Step S12, the focusing lens system 112 is driven along the optical axis of the taking lens device 11 to a fully extended position (referred to hereinafter as a “distal position”), and the processing proceeds to Step S13.

In Step S13, an exposure is performed for image-forming a subject on the imaging device 21, and the processing proceeds to Step S14.

In Step S14, an image signal for all pixels (e.g., an image signal for about three megapixels) is read from the imaging device 21, subjected to various processes, and then temporarily stored in the memory 23. Then, the processing proceeds to Step S15.

In Step S15, an address in the memory (or buffer) 23 for an image signal (or image) to be acquired and temporarily stored next is set at the address subsequent to the ending address of the image temporarily stored in Step S14, as shown in FIG. 7. Then, the processing proceeds to Step S16.

In Step S16, a determination is made as to whether or not the focusing lens system 112 is in a fully retracted position (referred to hereinafter as a “proximal position”) along the optical axis of the taking lens device 11. When the focusing lens system 112 is in the proximal position in Step S16, the processing proceeds to Step S18; otherwise, the processing proceeds to Step S17.

In Step S17, the focusing lens system 112 is driven a distance corresponding to the depth of field (1 Fδ) toward the retracted position (or proximal position). Then, the processing returns to Step S13. Thus, the processes in Steps S13 to S17 are repeated until the focusing lens system 112 reaches the proximal position. In other words, while the focusing lens system 112 is moved gradually in steps each corresponding to the depth of field from the distal position to the proximal position, images corresponding to the respective positions of the focusing lens system 112 are acquired. As a result, n images or n frames (e.g., n=10) containing stepwise different in-focus subjects are temporarily stored in the memory 23. In this manner, the photographing operation is carried out wherein the plurality of images corresponding to the respective photographing conditions are acquired while the plurality of photographing conditions regarding “focusing” are successively adopted in time sequence. Then, the actual photographing operation including the exposures, image signal readings and the like in the imaging device 21 is completed.

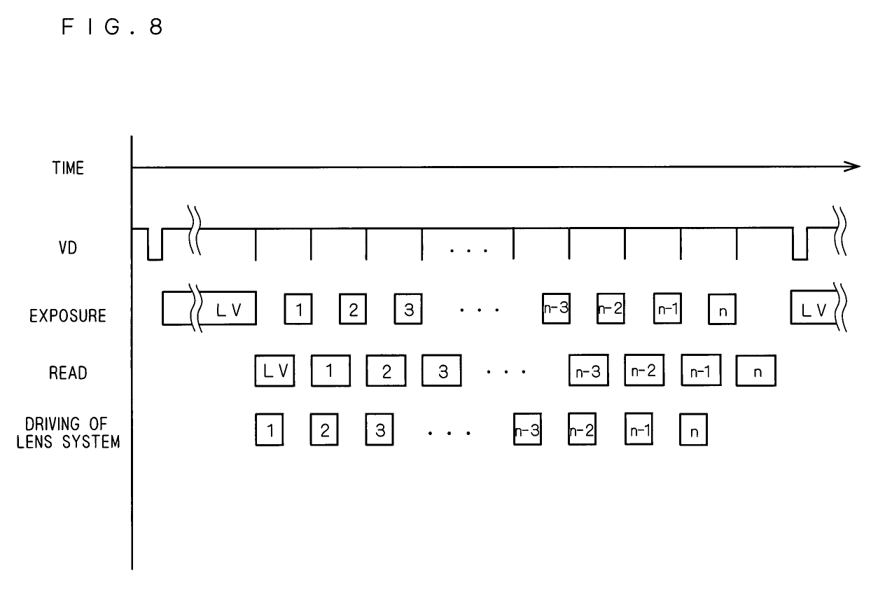

FIG. 8 is a timing diagram showing exposure timing, image signal read timing and the timing of the driving of the focusing lens system 112 in the photographing condition specification mode. The timing diagram in the case where only “focusing” is selected as the variable condition item is illustrated in FIG. 8. The exposure timing and read timing for the live view display before and after the actual photographing are denoted by the character LV.

In the actual photographing operation in the photographing condition specification mode, the first, second, third, . . . , (n-3)th, (n-2)th, (n-1)th and n-th processes of driving the focusing lens system 112, exposures and image signal readings are executed in time sequence in response to the generation of a vertical synchronization signal (VD), as shown in FIG. 8.

Referring again to the flow chart of FIG. 6, description will be continued.

When the processing proceeds from Step S16 to Step S18, the actual photographing operation is completed, and the storage processing operation starts. To this end, the rate (frame rate) at which the image signal is read from the imaging device 21 is changed from 300 frames per second (300 fps) to 30 frames per second (30 fps) in Step S18. Then, the processing proceeds to Step S19. Thus, in response to the completion of the actual photographing operation, the frame rate of the imaging device 21 is changed back to the same frame rate as the frame rate (30 fps) used prior to the issue of the photographing start instruction or prior to the start of the actual photographing operation.

The specific photographing condition specified by the user and stored in the RAM 202 prior to the actual photographing is read in Step S19. Then, the processing proceeds to Step S20.

In Step S20, the single image that most satisfies the specific photographing condition is extracted from among the n images or n frames temporarily stored in the memory 23 by repeating the processes in Steps S13 to S17. Then, the processing proceeds to Step S21. Specifically, in Step S20, the focusing computation part 25 calculates the AF evaluation value for each of the n images or n frames temporarily stored in the memory 23, using the box 300 defined prior to the photographing on the condition specification screen G shown in FIG. 5 as the AF area. Then, the controller 20 extracts the image corresponding to the maximum one of the AF evaluation values calculated for the respective images as an image in which the most in-focus condition of the subject specified using the box 300 is attained. Thus, the image which meets the specific photographing condition specified prior to the photographing is extracted in this manner.

In Step S21, the image extracted in Step S20 is stored in the memory card 9. Then, the processing proceeds to Step S22. The image extracted in Step S20 may be subjected to a compression process with a predetermined compression ratio and then be stored in the memory card 9 in Step S21.

In Step S22, the remainder of the n images or n frames temporarily stored in the memory 23 which are not extracted in Step S20 are deleted as unneeded images from the memory 23. Thus, the storage processing operation is completed, and the operational flow shown in FIG. 6 is completed.

As described above, the image capturing apparatus 1 set in the photographing condition specification mode performs the actual photographing operation in which, for example, the plurality of images corresponding to the respective positions of the focusing lens system 112 are acquired in time sequence, with the specific photographing condition regarding “focusing” specified by the user prior to the actual photographing operation. After the actual photographing operation, the image that most satisfies the specific photographing condition is automatically extracted from among the plurality of images acquired during the actual photographing operation and stored in the memory card 9. The remaining images are deleted. Such operations allows the user to easily obtain a desired image.

### Specification of Photographing Conditions Regarding Exposure, White Balance and Image Magnification, and Operational Flow

Although only “focusing” is selected as the variable condition item in the above description for simplicity of discussion, the case where other items are selected as the variable condition items will be described below. It is assumed that, if “focusing” is not selected as the variable condition item, the position of the AF area relative to the image is arbitrarily definable on the live view display in response to the press of the cross switch 171 by the user, as shown in FIG. 5.

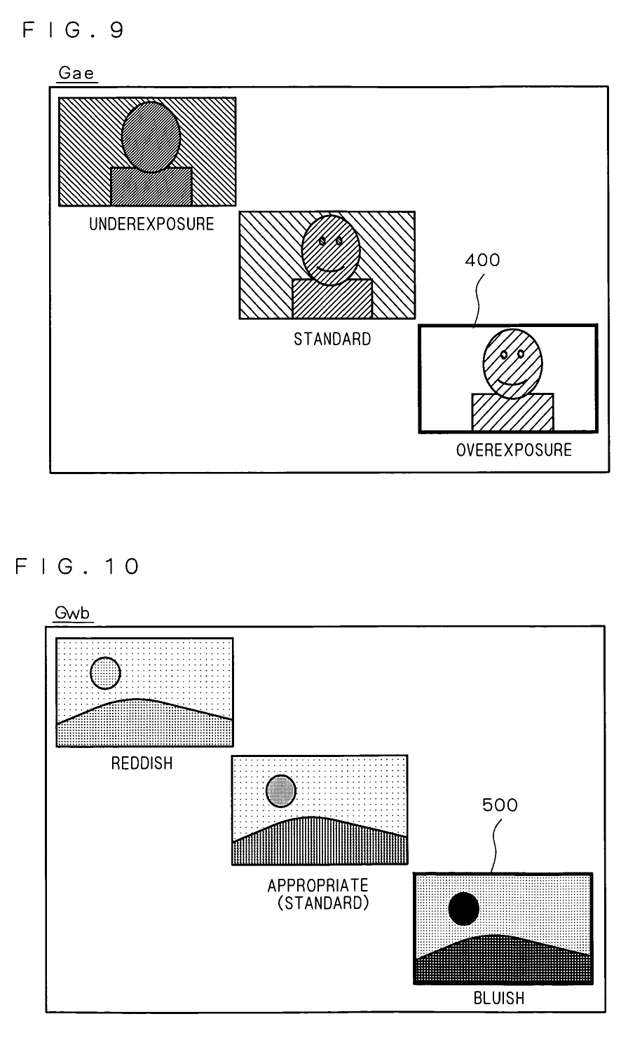

FIG. 9 is a view illustrating a screen (or condition specification screen) Gae for specification of the single photographing condition (or specific photographing condition) regarding the exposure in the case where “exposure” is selected as the variable condition item. If only “exposure” is selected as the variable condition item, the screen displayed on the LCD 16 is changed from the selection screen shown in FIG. 4 to the condition specification screen Gae shown in FIG. 9.

With reference to FIG. 9, the condition specification screen Gae shows, for example, three sample images different in exposure condition from each other as superimposed on a live view image. The three sample images indicate three images with stepwise changing subject brightnesses. Specifically, the three sample images displayed herein correspond to the following three exposure conditions: an exposure condition (referred to hereinafter as an “underexposure condition”) of a relatively low subject brightness; an exposure condition (referred to hereinafter as a “standard exposure condition”) of a moderate subject brightness which is used as a standard of reference; and an exposure condition (referred to hereinafter as an “overexposure condition”) of a relatively high subject brightness. Thus, the underexposure condition, the standard exposure condition and the overexposure condition are in ascending order of subject brightness.

With the condition specification screen Gae displayed on the LCD 16, the user can place a box cursor 400 at the position of one of the three sample images by pressing the cross switch 171 as appropriate. With the box cursor 400 placed at the position of a desired one of the sample images, the user can specify the single exposure condition regarding “exposure” as the specific photographing condition by pressing the execution button 172 prior to the actual photographing operation.

In this example, the position of the AF area is indicated by the box 300 as shown in FIG. 5, and photographing the subject within the AF area under an exposure condition similar to that of the sample image is specified as the specific photographing condition. The specific photographing condition specified by the user is stored in the RAM 202.

Three sample images prepared in advance and stored in the ROM 201 or the like may be displayed on the condition specification screen Gae shown in FIG. 9. Alternatively, three sample images stepwise different in exposure condition from each other may be generated based on the image corresponding to the position of the AF area at that time, and be displayed on the LCD 16.

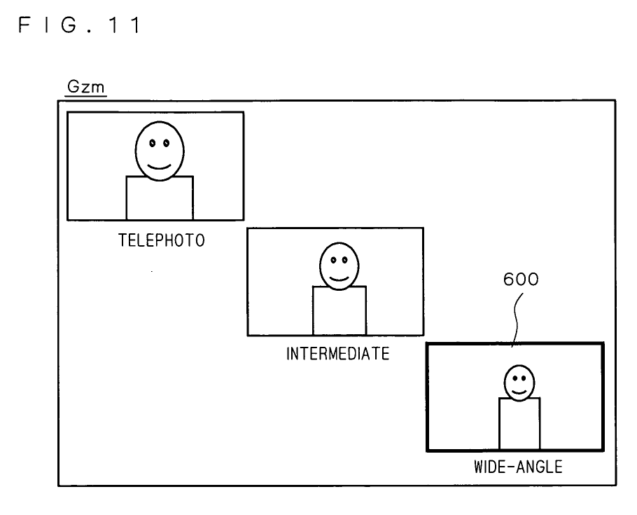

FIG. 10 is a view illustrating a screen (or condition specification screen) Gwb for specification of the single photographing condition (or specific photographing condition) regarding the white balance in the case where “white balance” is selected as the variable condition item. If only “white balance” is selected as the variable condition item, the screen displayed on the LCD 16 is changed from the selection screen shown in FIG. 4 to the condition specification screen Gwb shown in FIG. 10.

With reference to FIG. 10, the condition specification screen Gwb shows, for example, three sample images different in white balance condition from each other as superimposed on a live view image. The three sample images are reddish, appropriate (or standard), and bluish, respectively, throughout the images.

With the condition specification screen Gwb displayed on the LCD 16, the user can place a box cursor 500 at the position of one of the three sample images by pressing the cross switch 171 as appropriate. With the box cursor 500 placed at the position of a desired one of the sample images, the user can specify the single photographing condition regarding “white balance” as the specific photographing condition by pressing the execution button 172.

In this example, acquiring an image under a white balance condition similar to that of the specified sample image is specified as the specific photographing condition. The specific photographing condition specified by the user is stored in the RAM 202.

Three sample images prepared in advance and stored in the ROM 201 or the like may be displayed on the condition specification screen Gwb shown in FIG. 10. Alternatively, three sample images stepwise different in white balance condition from each other may be generated based on a live view image at that time, and be displayed on the LCD 16.

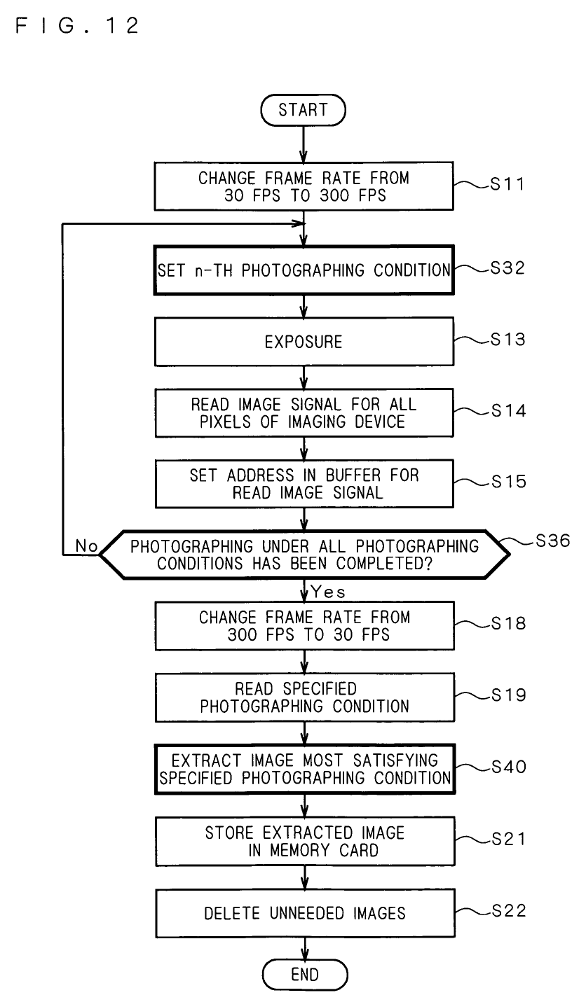

FIG. 11 is a view illustrating a screen (or condition specification screen) Gzm for specification of the single photographing condition (or specific photographing condition) regarding the image magnification in the case where “image magnification” is selected as the variable condition item. If only “image magnification” is selected as the variable condition item, the screen displayed on the LCD 16 is changed from the selection screen shown in FIG. 4 to the condition specification screen Gzm shown in FIG. 11.

With reference to FIG. 11, the condition specification screen Gzm shows, for example, three sample images different in image magnification condition from each other as superimposed on a live view image. The three sample images are stepwise different in the size of a person relative to the image size from each other.

With the condition specification screen Gzm displayed on the LCD 16, the user can place a box cursor 600 at the position of one of the three sample images by pressing the cross switch 171 as appropriate. With the box cursor 600 placed at the position of a desired one of the sample images, the user can specify the single photographing condition regarding “image magnification” as the specific photographing condition by pressing the execution button 172.

In this example, acquiring an image at an image magnification which provides the same size of the person relative to the image size as that in the specified sample image is specified as the specific photographing condition. The specific photographing condition specified by the user is stored in the RAM 202.

Three sample images prepared in advance and stored in the ROM 201 or the like may be displayed on the condition specification screen Gzm shown in FIG. 11. Alternatively, three sample images at three different digital zoom magnifications may be generated by means of digital zoom using a live view image at that time, and be displayed on the LCD 16.

Thus, the user can specify the specific photographing condition for each variable condition item.

FIG. 12 is an operational flow chart illustrating the actual photographing and storage process of the image capturing apparatus 1 in the case where one of the items “exposure,” “white balance” and “image magnification” is selected as the variable condition item, and the specific photographing condition regarding the variable condition item is specified. Because this operational flow chart includes many process steps similar to those in the flow chart shown in FIG. 6, same reference characters are used to designate the process steps similar to those of FIG. 6. Like the operational flow shown in FIG. 6, the operational flow shown in FIG. 12 is implemented also under the control of the controller 20.

As described above, when the user presses the shutter release button 13 into the fully pressed position (S2) after specifying the specific photographing condition on one of the condition specification screens Gae, Gwb, Gzm as shown in FIGS. 9 to 11, the operational flow shown in FIG. 12 starts, and the processing proceeds to Step S11 of FIG. 12. In Step S11, the frame rate is changed from 30 frames per second (30 fps) to 300 frames per second (300 fps). Then, the processing proceeds to Step S32.

In Step S32, an n-th photographing condition (where n is a positive integer) is set among the plurality of photographing conditions established in accordance with the selection of the variable condition item. Then, the processing proceeds to Step S13. The first one of the plurality of photographing conditions is set for the first execution of Step S32, and the n-th one of the plurality of photographing conditions is set for the n-th execution of Step S32.

Subsequently, an exposure is performed for image-forming a subject on the imaging device 21 (in Step S13). An image signal for all pixels is read from the imaging device 21 and then temporarily stored in the memory 23 (in Step S14). An address in the buffer is set (in Step S15). Then, the processing proceeds to Step S36.

In Step S36, a determination is made as to whether or not photographing has been completed under all photographing conditions regarding the variable condition item. If photographing has not yet been completed under all photographing conditions in Step S36, the processing returns to Step S32, and the processes in Steps S32, S13, S14, S15 and S36 are repeated until photographing are completed under all photographing conditions. If photographing has already been completed under all photographing conditions, the processing proceeds to Step S18. In other words, the photographing operation is carried out wherein the plurality of images corresponding to the respective photographing conditions are acquired while the plurality of photographing conditions regarding each variable condition item are successively adopted in time sequence. Then, the actual photographing operation including the exposures and image signal readings in the imaging device 21 is completed.

The rate (frame rate) at which the image signal is read from the imaging device 21 is changed from 300 frames per second (300 fps) to 30 frames per second (30 fps) (in Step S18). The specific photographing condition specified by the user and stored in the RAM 202 prior to the actual photographing is read (in Step S19). Then, the processing proceeds to Step S40.

In Step S40, the single image that most satisfies the specific photographing condition is extracted from among the n images or n frames temporarily stored in the memory 23 by repeating the processes in Steps S32, S13, S14, S15 and S36. Then, the processing proceeds to Step S21.

Specifically, the following process is executed in Step S40. When the variable condition item is “exposure,” an image corresponding to an exposure condition which is closest to the sample image corresponding to the specified exposure condition for a subject within the AF area is extracted, for example, from among the n images or n frames temporarily stored in the memory 23. When the variable condition item is “white balance,” an image corresponding to a white balance which is closest to the sample image corresponding to the specified white balance is extracted, for example, from among the n images or n frames temporarily stored in the memory 23. When the variable condition item is “image magnification,” the size of the face of the subject is detected for each of the n images or n frames temporarily stored in the memory 23, for example, by using the extraction of skin color, the contour of the face or the like. Then, an image containing (the face of) a person the size of which is closest to that contained in the sample image corresponding to the specified image magnification is extracted.

Thereafter, the image extracted in Step S40 is stored in the memory card 9 (in Step S21). The remainder of the n images or n frames temporarily stored in the memory 23 which are not extracted in Step S40 are deleted as unneeded images from the memory 23 (in Step S22). Thus, the storage processing operation is completed, and the operational flow shown in FIG. 12 is completed.

Although only one item is selected as the variable condition item in the above description, the image capturing apparatus 1 is capable of selecting two or more items as the variable condition items. When, for example, two variable condition items are selected, the image capturing apparatus 1 can provide stepwise different photographing conditions regarding each of the two variable condition items to perform photographing under a plurality of photographing conditions which are all possible combinations of the conditions of one of the two variable condition items and the conditions of the other variable condition item, and then extract the single image that most satisfies the specific photographing condition specified by the user. Thus, the user can select at least one item from among “focusing,” “exposure,” “image magnification” and “white balance” as the variable condition item.

As described hereinabove, the image capturing apparatus 1 according to the preferred embodiment of the present invention, when in the photographing condition specification mode, sets the plurality of photographing conditions corresponding to the variable condition item in response to the selection of the variable condition item by the user. Subsequently, the user specifies the single photographing condition (or specific photographing condition) regarding the variable condition item prior to the actual photographing operation. In response to the photographing start instruction given by the user, the image capturing apparatus 1 acquires the plurality of images corresponding to the respective photographing conditions regarding the variable condition item in time sequence to temporarily store the plurality of images in the memory 23. Thereafter, the image capturing apparatus 1 automatically extracts the image that most satisfies the specific photographing condition specified prior to the actual photographing operation by the user from among the plurality of images temporarily stored in the memory 23, to store the extracted image in the memory card 9. The remainder of the images which are not extracted at this time are deleted. Thus, the image capturing apparatus 1 is configured to perform photographing the plurality of times (or capture the plurality of images) under the different photographing conditions to evaluate the captured images based on the photographing conditions, thereby extracting the image that most satisfies the specific photographing condition. Such a configuration achieves the automatic extraction and storage of a desired image without the need to execute a compression process with a high compression ratio due to the problem of the capacity of the memory card 9 and the like. This consequently improves the probability of easy obtainment of a desired image on every occasion even if there is an abrupt change in photographic situation.

Additionally, the frame rate in the imaging device 21 is increased in response to the photographing start instruction in accordance with the user's manipulation. Such an arrangement allows the easy acquisition of the plurality of images under the stepwise changing photographing conditions within substantially the same composition, thereby to increase the probability of obtainment of a desired image. Moreover, the use of the higher frame rate when needed suppresses unwanted power consumption.

Further, the frame rate in the imaging device 21 is changed back to the frame rate used prior to the issue of the photographing start instruction, in response to the completion of the actual photographing operation. Thus, the use of the higher frame rate only during the photographing operation in which a plurality of images are required to be acquired within substantially the same composition further suppresses unwanted power consumption.

### Modifications

Although the preferred embodiment of the present invention has been described above, the present invention is not limited to the specific form described above.

In the photographing condition specification mode according to the above-mentioned preferred embodiment, for example, the single image that most satisfies the specific photographing condition is extracted from among the plurality of images temporarily stored in the memory 23, and is stored in the memory card 9 whereas the remaining images not extracted are deleted from the memory 23. The present invention is not limited to this, but the following modification may be made. The image extracted as most satisfying the specific photographing condition is subjected to a compression process with a predetermined compression ratio whereas the remaining images not extracted are subjected to a compression process with a compression ratio relatively higher than the predetermined compression ratio, whereby all of the plurality of images are stored in the memory card 9. With such an arrangement, if after the photographing the user does not feel satisfaction with the single photographing condition specified by the user, other images cover the dissatisfaction because the images corresponding to other photographing conditions are also stored in the memory card 9.

For the automatic extraction of the desired image not subjected to the compression process with the high compression ratio, the remaining images not extracted, therefore, may be either deleted or subjected to the compression process and the like with a relatively higher compression ratio than the predetermined compression ratio used for the extracted image. In other words, the image capturing apparatus 1 may perform the image processing including at least one of specific processes (i.e., at least one of the processes: “the compression process”, “the deletion process”, and the like) on at least one or all of the plurality of images temporarily stored in the memory 23 so that each of the images not extracted is relatively lower in data capacity than the extracted image, and then perform the storage process for storing the image data resulting from the image processing in the memory card 9. The term “relatively lower in data capacity” not only means the mere decrease in data capacity caused by the increase in compression ratio and the like, but also is meant to include the data capacity equaling zero caused by the data deletion.

Although the acquisition of the single still image is described in the above-mentioned preferred embodiment, the present invention is not limited to such a specific form, but may be applied to the capturing of a moving image. Specifically, repeating the operation of extracting the image that most satisfies the specific photographing condition as mentioned above provides a moving image composed of a plurality of desired high-quality images. That is, the image capturing apparatus 1 can provide a moving image composed of only images in which a desired subject is in focus or images captured under desired exposure and white balance conditions and at a desired image magnification and the like. In this modification, the moving image displayed on the LCD 16 during the capturing of the moving image is composed of still images updated, for example, every 1/30 of a second, and the imaging device 21 outputs an image signal at a frame rate (e.g., 300 frames per second) relatively higher than the frame rate used during the image display.

Thus, the image capturing apparatus 1 can capture the images at the higher frame rate than the frame rate used during the image display while changing the photographing conditions as appropriate to extract a desired one of the plurality of images obtained within a period of time corresponding to a time interval at which the displayed images are updated, thereby achieving the smooth moving image.

Also during the live view display, the image capturing apparatus 1 may repeat the operation of extracting the image that most satisfies the specific photographing condition as mentioned above to produce on the LCD 16 only a live view display composed of a plurality of desired high-quality live view images in a similar manner to the moving image capturing. That is, the image capturing apparatus 1 can produce on the LCD 16 a live view display composed of only live view images in which a desired subject is in focus or live view images captured under desired exposure and white balance conditions and at a desired image magnification and the like. In this modification, the live view images displayed on the LCD 16 are updated, for example, every 1/30 of a second, and the imaging device 21 outputs an image signal at a frame rate (e.g., 300 frames per second) relatively higher than the frame rate used during the image display.

Thus, the image capturing apparatus 1 can capture the images at the higher frame rate than the frame rate used during the display of the live view images while changing the photographing conditions as appropriate to extract a desired one of the plurality of images obtained within a period of time corresponding to a time interval at which the live view images are updated, thereby achieving the production of the smooth live view display (i.e., moving image) on the LCD 16.

While the invention has been described in detail, the foregoing description is in all aspects illustrative and not restrictive. It is understood that numerous other modifications and variations can be devised without departing from the scope of the invention.

What is claimed is:

1. An image capturing apparatus comprising:
an imaging part for outputting an image signal at a frame rate relatively higher than a frame rate for use during image display;
a setting part for setting a plurality of photographing conditions regarding a predetermined photographing condition item;
a specification part for specifying a first condition regarding said predetermined photographing condition item prior to a photographing operation;
a photographing control part for causing said imaging part to perform said photographing operation for acquiring a plurality of images corresponding to said plurality of photographing conditions, respectively, while successively adopting said plurality of photographing conditions in time sequence;
an extraction part for extracting an image that most satisfies said first condition from among said plurality of images; and
a storage control part for performing image processing on at least one or all of said plurality of images so that each of a remainder of said plurality of images not extracted by said extraction part is relatively lower in data capacity than said image extracted by said extraction part, to effect a storage process for storing a result of said image processing in a storage medium.

2. The image capturing apparatus according to claim 1, wherein
said predetermined photographing condition item includes at least one item among focusing, exposure, image magnification and white balance.

3. The image capturing apparatus according to claim 1, wherein
said storage process includes a process of storing said image extracted by said extraction part in said storage medium while deleting said remainder of said plurality of images not extracted by said extraction part.

4. The image capturing apparatus according to claim 1, wherein
said storage process includes a process of performing a compression process with a predetermined compression ratio on said image extracted by said extraction part while performing a compression process with a compression ratio relatively higher than said predetermined compression ratio on said remainder of said plurality of images not extracted by said extraction part, to store said plurality of images in said storage medium.

5. The image capturing apparatus according to claim 1, further comprising:
an instruction part for issuing a start instruction of said photographing operation; and
a change part for changing a frame rate in said imaging part to a relatively higher frame rate than a frame rate used prior to an issue of said start instruction in response to said start instruction.

6. The image capturing apparatus according to claim 5, wherein
said change part changes a frame rate in said imaging part to a frame rate used prior to said issue of said start instruction in response to a completion of said photographing operation.

7. An image capturing apparatus comprising:
a setting part for setting a plurality of photographing conditions regarding a predetermined photographing condition item;
a specification part for specifying a first condition regarding said predetermined photographing condition item prior to a photographing operation;
a photographing control part for causing a predetermined imaging part to perform said photographing operation for acquiring a plurality of images corresponding to said plurality of photographing conditions, respectively, while successively adopting said plurality of photographing conditions in time sequence;
an extraction part for extracting an image that most satisfies said first condition from among said plurality of images; and
a storage control part for performing image processing on at least one or all of said plurality of images so that each of a remainder of said plurality of images not extracted by said extraction part is relatively lower in data capacity than said image extracted by said extraction part, to effect a storage process for storing a result of said image processing in a storage medium.

8. A method of acquiring an image, comprising the steps of:
(a) setting a plurality of photographing conditions regarding a predetermined photographing condition item;
(b) specifying a first condition regarding said predetermined photographing condition item prior to a photographing operation;
(c) using an imaging part for outputting an image signal at a frame rate relatively higher than a frame rate for use during image display to acquire a plurality of images corresponding to said plurality of photographing conditions, respectively, while successively adopting said plurality of photographing conditions in time sequence;
(d) extracting an image that most satisfies said first condition from among said plurality of images; and
(e) performing image processing on at least one or all of said plurality of images so that each of a remainder of said plurality of images not extracted in said step (d) is relatively lower in data capacity than said image extracted in said step (d), to effect a storage process for storing a result of said image processing in a storage medium.

9. The method according to claim 8, wherein
said predetermined photographing condition item includes at least one item among focusing, exposure, image magnification and white balance.

10. The method according to claim 8, wherein
said storage process includes a process of storing said image extracted in said step (d) in said storage medium while deleting said remainder of said plurality of images not extracted in said step (d).

11. The method according to claim 8, wherein
said storage process includes a process of performing a compression process with a predetermined compression ratio on said image extracted in said step (d) while performing a compression process with a compression ratio relatively higher than said predetermined compression ratio on said remainder of said plurality of images not extracted in said step (d), to store said plurality of images in said storage medium.

12. The method according to claim 8, further comprising the steps of:
(f) issuing a start instruction of said photographing operation; and
(g) changing a frame rate in said imaging part to a relatively higher frame rate than a frame rate used prior to an issue of said start instruction in response to said start instruction.

13. The method according to claim 12, further comprising the step of
(h) changing a frame rate in said imaging part to a frame rate used prior to said issue of said start instruction in response to a completion of said photographing operation.

14. A method of acquiring an image, comprising the steps of:
(a) setting a plurality of photographing conditions regarding a predetermined photographing condition item;
(b) specifying a first condition regarding said predetermined photographing condition item prior to a photographing operation;
(c) using a predetermined imaging part to acquire a plurality of images corresponding to said plurality of photographing conditions, respectively, while successively adopting said plurality of photographing conditions in time sequence;
(d) extracting an image that most satisfies said first condition from among said plurality of images; and
(e) performing image processing on at least one or all of said plurality of images so that each of a remainder of said plurality of images not extracted in said step (d) is relatively lower in data capacity than said image extracted in said step (d), to store a result of said image processing in a storage medium.
